(19) United States
(12) Patent Application Publication
(10) Pub. No.: US 2026/0274244 A1
(43) Pub. Date: Sep. 17, 2026

(54) CONTROL DEVICE FOR HYBRID ELECTRIC VEHICLE

(71) Applicant: TOYOTA JIDOSHA KABUSHIKI KAISHA, Toyota-shi (JP)

(72) Inventors: Shingo KORENAGA, Nagoya-shi (JP); Koichi Kitaura, Ebina-shi (JP); Takahiko Fujiwara, Sunto-gun (JP); Hiroshi Kobayashi, Numazu-shi (JP)

(73) Assignee: TOYOTA JIDOSHA KABUSHIKI KAISHA, Toyota-shi (JP)

(21) Appl. No.: 19/444,565

(22) Filed: Jan. 9, 2026

(30) Foreign Application Priority Data
Mar. 12, 2025 (JP) 2025-039750

(51) Int. Cl. B60W 20/15; H02J 7/14

(52) U.S. Cl. CPC B60W 20/15; H02J 7/1446; B60W 2510/0676; B60W 2510/244

(57) ABSTRACT

A control device mounted on a hybrid electric vehicle determines whether a fuel-cut delay condition is satisfied, when a fuel-cut condition of an internal combustion engine is satisfied. When the fuel-cut delay condition is satisfied, the control device delays execution of fuel cut of the internal combustion engine for a predetermined period. The control device sets an engine air-fuel ratio during the predetermined period to a target air-fuel ratio that is within an exhaust control window of a three-way catalyst and leaner than the stoichiometric air-fuel ratio. The control device controls a generator such that output generated by the internal combustion engine during the predetermined period is used to charge a battery.

### CROSS-REFERENCE TO RELATED APPLICATION

This application claims priority to Japanese Patent Application No. 2025-039750 filed on March 12, 2025. The disclosure of the above-identified application, including the specification, drawings, and claims, is incorporated by reference herein in its entirety.

### BACKGROUND

### 1. Technical Field

The present disclosure relates to control devices for hybrid electric vehicles.

### 2. Description of Related Art

A technique is known in which, when the temperature of an exhaust control catalyst disposed in the exhaust passage of an internal combustion engine is high, execution of fuel cut is delayed, the engine air-fuel ratio is set to a lean air-fuel ratio during the delay period, and the length of the delay period is determined according to the amount of oxygen stored in the exhaust control catalyst (see, for example, Japanese Unexamined Patent Application Publication No. 2009-191665 (JP 2009-191665 A)).

### SUMMARY

An object of the present disclosure is to provide a technique capable of suitably suppressing degradation of a three-way catalyst caused by fuel cut of an internal combustion engine.

One aspect of the present disclosure is a control device for a hybrid electric vehicle equipped with an internal combustion engine, a battery, and a generator.

A three-way catalyst having oxygen storage capacity is disposed in an exhaust passage of the internal combustion engine.

The generator is configured to charge the battery using output of the internal combustion engine.

The control device is configured to

determine whether a fuel-cut delay condition is satisfied, when a fuel-cut condition of the internal combustion engine is satisfied,

delay execution of fuel cut of the internal combustion engine for a predetermined period when determination is made that the fuel-cut delay condition is satisfied,

set an engine air-fuel ratio during the predetermined period to a target air-fuel ratio that is within an exhaust control window of the three-way catalyst and leaner than the stoichiometric air-fuel ratio, and

control the generator such that the output generated by the internal combustion engine during the predetermined period is used to charge the battery.

The present disclosure can provide a technique capable of suitably suppressing degradation of a three-way catalyst caused by fuel cut of an internal combustion engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of a schematic configuration of a vehicle according to an embodiment;

FIG. 2 is a block diagram showing an example of the software configuration of an electronic control unit (ECU) according to the embodiment;

FIG. 3 is a graph showing an example of the correlation among engine output, engine air-fuel ratio (A/F), and the amount of oxygen supplied to a three-way catalyst per cycle;

FIG. 4 is a timing chart showing an example of changes over time in oxygen storage amount (OSA) of the three-way catalyst, degradation suppression flag, allowable output power, fuel cut (F/C) condition, and fuel cut (F/C);

FIG. 5 is a flowchart showing an example of a first processing routine executed by the ECU for each cycle; and

FIG. 6 is a flowchart showing an example of a second processing routine executed by the ECU when the F/C condition is satisfied.

### DETAILED DESCRIPTION OF EMBODIMENTS

For vehicles equipped with an internal combustion engine in which a three-way catalyst having oxygen storage capacity is disposed in an exhaust passage, a technique has been proposed in which, when the temperature of the three-way catalyst is high at the time a fuel-cut condition is satisfied, execution of fuel cut is delayed while operating the internal combustion engine at a lean air-fuel ratio. With this technique, oxygen can be gradually stored in the three-way catalyst before fuel cut is executed. This suppresses the occurrence of a rapid oxygen storage reaction when fuel cut is executed, thereby suppressing thermal degradation of the three-way catalyst.

Since fuel cut is executed when output from the internal combustion engine is not needed, such as during deceleration of the vehicle, the engine output should be kept as small as possible during the fuel-cut delay period. To that end, the engine air-fuel ratio (i.e., the air-fuel ratio of the air-fuel mixture burned in the internal combustion engine) must be raised as much as possible (i.e., made as lean as possible). Consequently, the engine air-fuel ratio may fall outside the exhaust control window of the three-way catalyst. As a result, emissions may worsen during the fuel-cut delay period. Therefore, it is desirable to suitably suppress degradation of the three-way catalyst caused by fuel cut.

The control device according to the present disclosure is applied to a hybrid electric vehicle equipped with an internal combustion engine in which a three-way catalyst having oxygen storage capacity is disposed in an exhaust passage, a drive battery, and a generator configured to charge the battery using output of the internal combustion engine. The control device according to the present disclosure determines whether a fuel-cut delay condition is satisfied, when a fuel-cut condition of the internal combustion engine is satisfied. The fuel-cut delay condition may include that the amount of oxygen stored in the three-way catalyst is less than a predetermined amount. In that case, the predetermined amount may be, for example, an amount corresponding to about 40% of the maximum amount of oxygen that can be stored by the three-way catalyst (i.e., an amount obtained by multiplying the maximum amount of oxygen by 0.4). The fuel-cut delay condition may include that the temperature of the three-way catalyst is higher than or equal to a predetermined temperature, in addition to that the amount of oxygen stored in the three-way catalyst is less than the predetermined amount. In that case, the predetermined temperature may be, for example, about 700°C.

The control device according to the present disclosure delays execution of fuel cut of the internal combustion engine for a predetermined period when it is determined that the fuel-cut delay condition is satisfied. That is, the control device according to the present disclosure continues to fire the internal combustion engine (i.e., continues to inject fuel and burn the air-fuel mixture) until the predetermined period has elapsed after the fuel-cut condition is satisfied. At that time, the control device according to the present disclosure sets the engine air-fuel ratio to a target air-fuel ratio, and controls the generator such that the output of the internal combustion engine is used to charge the battery. The target air-fuel ratio in the present disclosure is an air-fuel ratio that is within the exhaust control window of the three-way catalyst and leaner than the stoichiometric air-fuel ratio.

In the control device for a hybrid electric vehicle according to the present disclosure, since the engine air-fuel ratio during the predetermined period is set to the target air-fuel ratio described above, deterioration of emissions during the predetermined period can be suppressed. By setting the engine air-fuel ratio during the predetermined period to the target air-fuel ratio described above, even when the output of the internal combustion engine becomes relatively large, this output can be offset by charging the battery. Accordingly, a decrease in drivability during the predetermined period can also be suppressed. Furthermore, since the output generated by the internal combustion engine during the predetermined period can be offset by charging the battery, the target air-fuel ratio can be set to a less lean air-fuel ratio (an air-fuel ratio closer to the stoichiometric air-fuel ratio). In that case, deterioration of emissions during the predetermined period can be more reliably suppressed.

### Embodiment

A specific embodiment of the present disclosure will now be described with reference to the drawings. Unless otherwise specified, the dimensions, materials, shapes, and relative arrangements of the components described in the embodiment are not intended to limit the technical scope of the disclosure to the illustrated examples alone.

### Overview of Vehicle

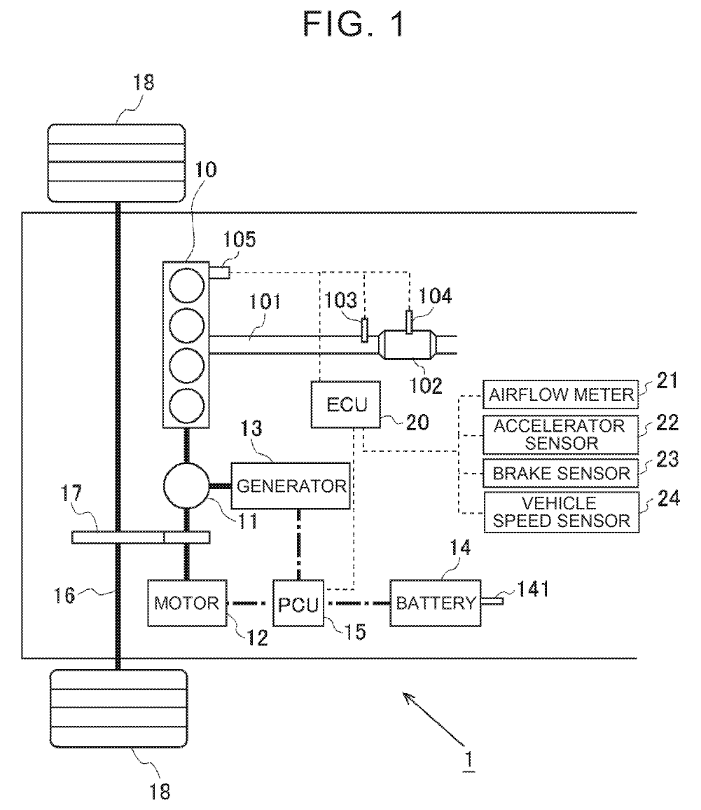

FIG. 1 illustrates an example of a schematic configuration of a hybrid electric vehicle to which the present disclosure is applied. A vehicle 1 according to the embodiment is a hybrid electric vehicle (HEV) or a plug-in hybrid electric vehicle (PHEV) and is equipped with a hybrid system. As shown in FIG. 1, the hybrid system may include, for example, an internal combustion engine 10, a power split mechanism 11, a motor 12, a generator 13, a battery 14, a power control unit (PCU) 15, and a speed reducer 17. The configuration of the hybrid system is not limited to the example shown in FIG. 1, as long as the internal combustion engine 10 and the motor 12 can cooperatively drive wheels 18 serving as drive wheels and the hybrid system is configured such that the battery 14 can be charged using the output of the internal combustion engine 10.

The internal combustion engine 10 may be a spark-ignition internal combustion engine or a compression-ignition internal combustion engine. A crank position sensor 105 is attached to the internal combustion engine 10. The crank position sensor 105 detects the rotational speed of the output shaft (crankshaft) of the internal combustion engine 10. The crankshaft of the internal combustion engine 10 is connected via the power split mechanism 11 to the rotary shaft of the generator 13 and the rotary shaft of the motor 12.

The rotary shaft of the generator 13 is connected to the crankshaft of the internal combustion engine 10 via the power-split mechanism 11. The generator 13 primarily generates electric power using the kinetic energy of the crankshaft. The generator 13 may be configured to function as a starter motor that rotationally drives the crankshaft via the power split mechanism 11 when the internal combustion engine 10 is started. In other words, the generator 13 may be configured as a motor generator. Electric power generated by the generator 13 is stored in the battery 14 via the PCU 15 or supplied to the motor 12. A state-of-charge (SOC) sensor 141 is attached to the battery 14. The SOC sensor 141 detects the remaining charge (state of charge) of the battery 14.

The rotary shaft of the motor 12 is connected to an axle 16 via the speed reducer 17. The motor 12 rotationally drives the wheels 18 using electric power supplied from the battery 14 or the generator 13 via the PCU 15. The rotary shaft of the motor 12 is also connected to the power split mechanism 11. The motor 12 can assist the internal combustion engine 10 in rotationally driving the wheels 18. The motor 12 may be configured to perform regenerative power generation using the kinetic energy of the wheels 18 during deceleration of the vehicle 1. In other words, the motor 12 may be configured as a motor generator.

The power split mechanism 11 may include, for example, a planetary gear set, and performs power splitting among the internal combustion engine 10, the motor 12, and the generator 13. For example, the power split mechanism 11 adjusts the traveling speed of the vehicle 1 by operating the motor 12 while adjusting the amount of electric power generated by the generator 13, with the internal combustion engine 10 being operated in its most efficient operating region.

The PCU 15 includes components such as an inverter, a boost converter, and a direct current-to-direct current (DC-to-DC) converter. The PCU 15 is configured to: convert direct current power supplied from the battery 14 into alternating current power and supply it to the motor 12; convert alternating current power supplied from the generator 13 into direct current power and supply it to the battery 14; and adjust the voltage of power transferred between the inverter and the battery 14.

In the present embodiment, an exhaust pipe 101 is connected to the internal combustion engine 10. The exhaust pipe 101 forms a passage through which gas produced by combustion within the cylinders of the internal combustion engine 10 (exhaust gas) flows. A catalyst casing 102 that houses a three-way catalyst is disposed along the exhaust pipe 101. In the present embodiment, the three-way catalyst supports ceria and has oxygen storage capacity (OSC). An air-fuel ratio sensor 103 is attached to the exhaust pipe 101 upstream of the catalyst casing 102. The air-fuel ratio sensor 103 detects the engine air-fuel ratio (i.e., the air-fuel ratio of the air-fuel mixture burned in the internal combustion engine 10) according to the oxygen concentration in the exhaust gas. A catalyst temperature sensor 104 is attached to the catalyst casing 102. The catalyst temperature sensor 104 detects the temperature (bed temperature) of the three-way catalyst.

The vehicle 1 configured as described above is equipped with an electronic control unit (ECU) 20. The ECU 20 can be configured as a computer that includes a processor (central processing unit (CPU), graphics processing unit (GPU), etc.), a main storage device (random access memory (RAM), read-only memory (ROM), etc.), and an auxiliary storage device (erasable programmable read-only memory (EPROM), hard disk drive, removable media, etc.). The auxiliary storage device stores an operating system (OS), various programs, various tables, and the like. By executing the stored programs, the processor implements the functions of the ECU 20 described below. Part or all of the functions may alternatively be implemented as, for example, hardware modules using hardware circuits such as application-specific integrated circuits (ASICs) or field programmable gate arrays (FPGAs). In the present embodiment, the ECU 20 is an example of the "control device" according to the present disclosure.

In the present embodiment, the crank position sensor 105, the SOC sensor 141, the air-fuel ratio sensor 103, and the catalyst temperature sensor 104 are connected to the ECU 20. In addition, a plurality of other sensors such as an airflow meter 21, an accelerator sensor 22, a brake sensor 23, and a vehicle speed sensor 24 are also connected to the ECU 20. The airflow meter 21 detects the intake air amount of the internal combustion engine 10. The accelerator sensor 22 detects the amount of operation of an accelerator pedal mounted on the vehicle 1 (accelerator operation amount). The brake sensor 23 detects the amount of operation of a brake pedal mounted on the vehicle 1. The vehicle speed sensor 24 detects the traveling speed of the vehicle 1. The ECU 20 controls the internal combustion engine 10, the motor 12, the generator 13, and the PCU 15 according to output signals from the above sensors. The ECU 20 may be formed by a plurality of ECUs.

### Software Configuration of ECU

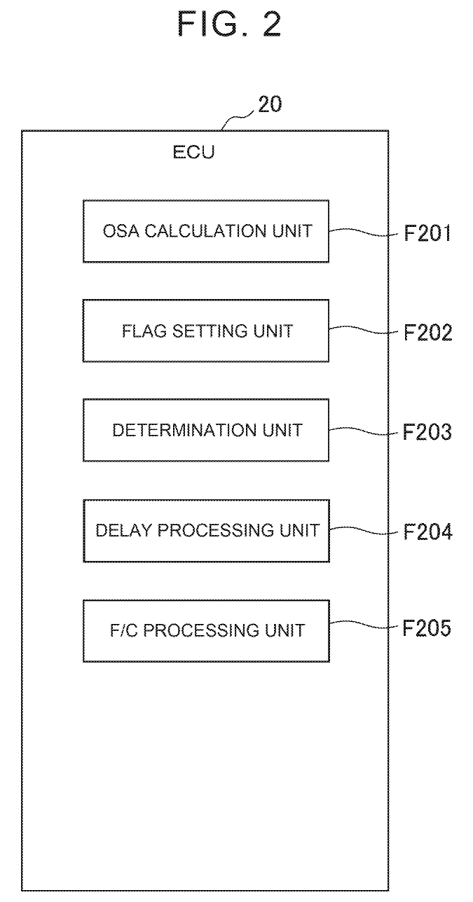

Next, the functions implemented by the ECU 20 in the present embodiment will be described. FIG. 2 is a block diagram showing an example of the software configuration of the ECU 20 according to the present embodiment. In the present embodiment, the processor of the ECU 20 includes a plurality of software modules such as an oxygen storage amount (OSA) calculation unit F201, a flag setting unit F202, a determination unit F203, a delay processing unit F204, and a fuel cut (F/C) processing unit F205. Each software module is implemented by the processor executing programs stored in the auxiliary storage device. At least part of these software modules may alternatively be implemented by hardware circuits such as ASICs or FPGAs. In the following description, the information processing executed by each of the OSA calculation unit F201, the flag setting unit F202, the determination unit F203, the delay processing unit F204, and the F/C processing unit F205 is equivalent to the information processing executed by the processor of the ECU 20.

The OSA calculation unit F201 calculates the amount of oxygen currently stored in the three-way catalyst (hereinafter referred to as "oxygen storage amount (OSA)"). The OSA may be calculated using known logic. For example, the calculation can be performed by integrating the balance between the amount of oxygen released from the three-way catalyst during rich operation of the internal combustion engine 10 (engine air-fuel ratio = rich air-fuel ratio) and the amount of oxygen stored in the three-way catalyst during lean operation the internal combustion engine 10 (engine air-fuel ratio = lean air-fuel ratio). The amount of oxygen released from the three-way catalyst and the amount of oxygen stored in the three-way catalyst can be calculated using the amount of exhaust gas flowing into the three-way catalyst (i.e., the sum of the intake air amount and the fuel injection amount) and the engine air-fuel ratio. This OSA calculation is repeatedly performed at predetermined intervals (for example, once per cycle) while the internal combustion engine 10 is operating. Every time the OSA calculation unit F201 calculates the OSA, it passes the calculation result (the latest OSA) to the flag setting unit F202 described later.

The flag setting unit F202 switches a degradation suppression flag between ON and OFF. In the present embodiment, the degradation suppression flag is turned ON when the three-way catalyst is in a predetermined state, and is turned OFF when the three-way catalyst is not in the predetermined state. For example, the degradation suppression flag may be implemented as a memory area set in the auxiliary storage device. In that case, the memory area simply stores data indicating whether the degradation suppression flag is ON or OFF, as set by the flag setting unit F202. The predetermined state refers to a state in which thermal degradation of the three-way catalyst could occur if fuel cut (F/C) is executed while the three-way catalyst is in the predetermined state. For example, the predetermined state may be a state in which the OSA is less than a first threshold (for example, a value corresponding to about 40% of the maximum amount of oxygen that can be stored by the three-way catalyst) and the bed temperature of the three-way catalyst is higher than or equal to a second threshold (for example, about 700°C).

Every time the OSA calculation unit F201 calculates the OSA, the flag setting unit F202 determines whether the three-way catalyst is in the predetermined state. Specifically, when the OSA is calculated by the OSA calculation unit F201, the flag setting unit F202 acquires the output signal of the catalyst temperature sensor 104 (i.e., the bed temperature of the three-way catalyst). The flag setting unit F202 then determines whether the OSA calculated by the OSA calculation unit F201 is less than the first threshold and whether the bed temperature detected by the catalyst temperature sensor 104 is higher than or equal to the second threshold. When the OSA is less than the first threshold and the bed temperature is higher than or equal to the second threshold, the flag setting unit F202 determines that the three-way catalyst is in the predetermined state. In that case, the flag setting unit F202 turns the degradation suppression flag ON. On the other hand, when the OSA is greater than or equal to the first threshold and/or the bed temperature is lower than the second threshold, the flag setting unit F202 determines that the three-way catalyst is not in the predetermined state. In that case, the flag setting unit F202 turns the degradation suppression flag OFF.

The determination unit F203 determines whether a fuel-cut delay condition is satisfied when a fuel-cut condition (F/C condition) is satisfied. The F/C condition may include, for example, that the engine speed calculated according to the output signal of the crank position sensor 105 is higher than or equal to a predetermined rotational speed, that the accelerator operation amount detected by the accelerator sensor 22 indicates a fully closed position, and that the traveling speed detected by the vehicle speed sensor 24 is higher than or equal to a predetermined speed. In the present embodiment, the fuel-cut delay condition includes that the three-way catalyst is in the predetermined state. In the present embodiment, when the three-way catalyst is in the predetermined state, the flag setting unit F202 turns the degradation suppression flag ON. When the three-way catalyst is not in the predetermined state, the flag setting unit F202 turns the degradation suppression flag OFF. Accordingly, in the present embodiment, when the F/C condition is satisfied, the determination unit F203 may simply determine whether the degradation suppression flag is ON or OFF. When the degradation suppression flag is ON, the determination unit F203 determines that the fuel-cut delay condition is satisfied. When the degradation suppression flag is OFF, the determination unit F203 determines that the fuel-cut delay condition is not satisfied.

The delay processing unit F204 executes a fuel-cut (F/C) delay process when the determination unit F203 determines that the fuel-cut delay condition is satisfied. In the present embodiment, the F/C delay process is a process that delays execution of fuel cut (F/C) until a predetermined period (the period until the OSA of the three-way catalyst becomes greater than or equal to the first threshold) has elapsed after the F/C condition is satisfied. During the predetermined period (the fuel-cut delay period), the delay processing unit F204 sets the engine air-fuel ratio to an air-fuel ratio that is leaner than the stoichiometric air-fuel ratio and within the exhaust control window of the three-way catalyst. In addition, the delay processing unit F204 controls the generator 13 via the PCU 15 such that all of the output generated by the internal combustion engine 10 during the F/C delay period is used to charge the battery 14.

When the delay processing unit F204 executes the F/C delay process, it sets an output (target output) to be generated by the internal combustion engine 10 during the predetermined period. In the present embodiment, all of the output generated by the internal combustion engine 10 during the predetermined period is used to charge the battery 14. Therefore, the target output of the internal combustion engine 10 is set according to the allowable output of the battery 14. As used herein, the "allowable output" refers to the output of the internal combustion engine 10 (engine output) that can be used to charge the battery 14. The allowable output varies depending on the battery state of charge. Accordingly, the delay processing unit F204 acquires the battery state of charge via the SOC sensor 141 and specifies the allowable output according to the acquired battery state of charge. The correlation between the battery state of charge and the allowable output may be obtained in advance through experiments or simulations and stored in the auxiliary storage device. The correlation between the battery state of charge and the allowable output may be stored in the form of a map or a function expression that allows the allowable output to be derived using the battery state of charge as an argument. The delay processing unit F204 sets the target output to an engine output equivalent to the allowable output specified according to the battery state of charge.

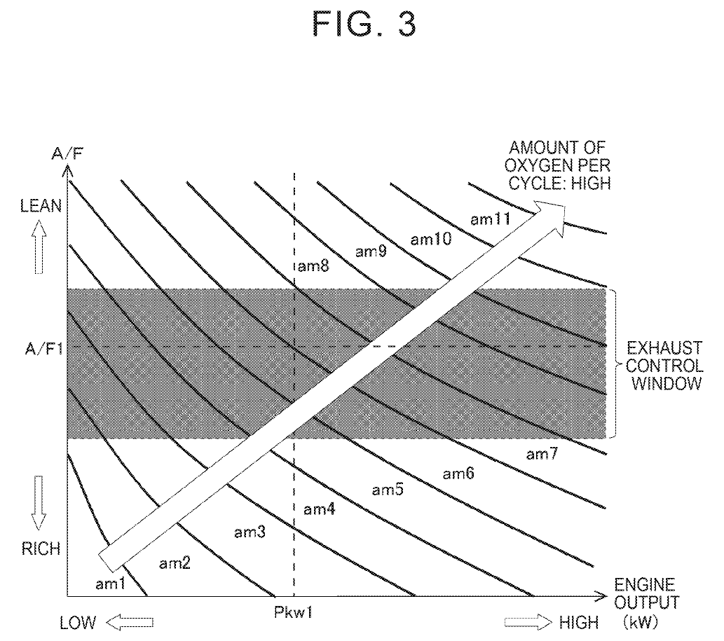

Once the target output is set as described above, the delay processing unit F204 sets a target value (target air-fuel ratio) of the engine air-fuel ratio during the predetermined period. In the present embodiment, the delay processing unit F204 sets the target air-fuel ratio using the correlation shown in FIG. 3. FIG. 3 is a graph showing the correlation among the engine output, the engine air-fuel ratio (A/F), and the amount of oxygen discharged from the internal combustion engine 10 per cycle (hereinafter also referred to as "discharged oxygen amount"). Such a correlation as exemplified in FIG. 3 may be obtained in advance through experiments or simulations and stored in the auxiliary storage device of the ECU 20. In FIG. 3, the discharged oxygen amount in each region between two adjacent continuous lines (each of the regions indicated by am1 to am11 in FIG. 3) is equal to that indicated by the solid line located on the lower-left side of the region.

For example, in the correlation shown in FIG. 3, the delay processing unit F204 may set the target air-fuel ratio as follows. Among the engine air-fuel ratios on the lean side (i.e., the engine air-fuel ratios higher than the stoichiometric air-fuel ratio) within the exhaust control window (the shaded region in FIG. 3), the delay processing unit F204 may select the engine air-fuel ratio at which the engine output matches the target output and the discharged oxygen amount is greatest, and set the target air-fuel ratio to that engine air-fuel ratio. When there are multiple engine air-fuel ratios at which the discharged oxygen amount is greatest, the delay processing unit F204 may select the lowest engine air-fuel ratio (i.e., the engine air-fuel ratio closest to the stoichiometric air-fuel ratio) from among those engine air-fuel ratios, and set the target air-fuel ratio to that engine air-fuel ratio. For example, when the target output is equal to Pkw1 in FIG. 3, the engine air-fuel ratio at which the discharged oxygen amount is greatest among the engine air-fuel ratios within the exhaust control window is an engine air-fuel ratio located in the region am7 in FIG. 3. Among the engine air-fuel ratios within the region am7 in FIG. 3, the lowest lean-side engine air-fuel ratio is A/F1 in FIG. 3. In such a case, the delay processing unit F204 may set the target air-fuel ratio to A/F1 in FIG. 3.

Once the target output and the target air-fuel ratio are set as described above, the delay processing unit F204 operates (fires) the internal combustion engine 10 in accordance with the set target output and target air-fuel ratio. The setting of the target output, the setting of the target air-fuel ratio, and the firing of the internal combustion engine 10 are repeatedly executed for each cycle. When the OSA calculated by the OSA calculation unit F201 becomes greater than or equal to the first threshold, and accordingly, the degradation suppression flag is switched from ON to OFF by the flag setting unit F202, the F/C delay process is ended.

The F/C processing unit F205 executes fuel cut (F/C) of the internal combustion engine 10 when the determination unit F203 determines that the fuel-cut delay condition is not satisfied, and when the F/C delay process executed by the delay processing unit F204 is completed. For example, the F/C processing unit F205 may stop fuel injection by the fuel injection valve(s) and also stop ignition by the spark plug(s). When the internal combustion engine 10 is a compression ignition internal combustion engine, the F/C processing unit F205 may simply stop fuel injection by the fuel injection valve(s).

### Timing Chart

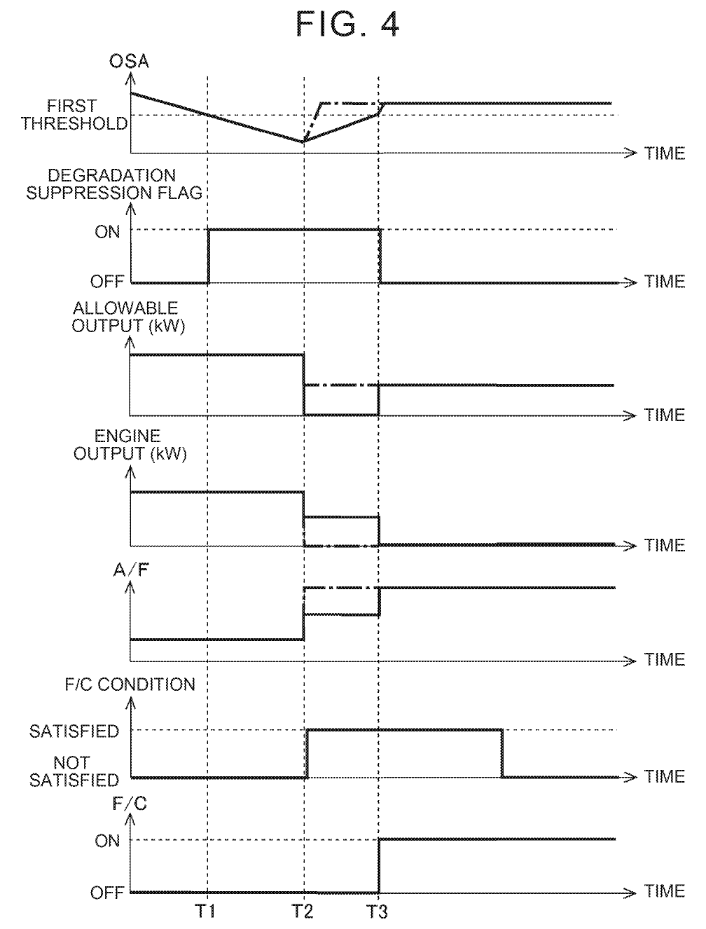

FIG. 4 is a timing chart showing transitions in OSA of the three-way catalyst, degradation suppression flag, allowable output, engine output, engine air-fuel ratio (A/F), F/C condition, and fuel cut (F/C). In the example shown in FIG. 4, when the OSA of the three-way catalyst falls below the first threshold during operation of the internal combustion engine 10 (time T1 in FIG. 4), the OSA calculated by the OSA calculation unit F201 becomes less than the first threshold, and accordingly, the flag setting unit F202 switches the degradation suppression flag from OFF to ON. Thereafter, when the F/C condition is satisfied while the degradation suppression flag is ON (that is, when the OSA of the three-way catalyst is below the first threshold) (time T2 in FIG. 4), the delay processing unit F204 executes the F/C delay process. Accordingly, after time T2, the allowable output of the battery 14 becomes smaller than the allowable output in the case where fuel cut (F/C) is executed (the long dashed short dashed line in FIG. 4). After time T2, the engine output becomes greater than the engine output in the case where fuel cut (F/C) is executed (the long dashed short dashed line in FIG. 4). After time T2, the engine air-fuel ratio (A/F) becomes lower than the engine air-fuel ratio in the case where fuel cut (F/C) is executed (the long dashed short dashed line in FIG. 4).

When the F/C delay process is executed, the OSA of the three-way catalyst increases more gradually than the OSA in the case where fuel cut (F/C) is executed (the long dashed short dashed line in FIG. 4). This suppresses the occurrence of a rapid oxygen storage reaction in the three-way catalyst, thereby suppressing a rapid temperature rise (bed temperature rise) of the three-way catalyst. In addition, all of the engine output generated during the F/C delay process can be used to charge the battery 14. Therefore, even when the engine output becomes relatively large during the F/C delay process, transmission of the engine output to the wheels 18 can be suppressed. Accordingly, the engine air-fuel ratio during the F/C delay process can be set to a lean air-fuel ratio that is within the exhaust control window and closer to the stoichiometric air-fuel ratio. As a result, an increase in emissions during the F/C delay process can be suppressed. By making the engine output during the F/C delay process relatively large, a sufficient amount of oxygen can be supplied to the three-way catalyst per cycle, thereby making it possible to shorten the execution period of the F/C delay process.

When execution of the F/C delay process causes the OSA of the three-way catalyst to increase to a value greater than or equal to the first threshold (time T3 in FIG. 4), the OSA calculated by the OSA calculation unit F201 becomes greater than or equal to the first threshold. Accordingly, the flag setting unit F202 switches the degradation suppression flag from ON to OFF. When the degradation suppression flag is switched from ON to OFF, the delay processing unit F204 ends the F/C delay process, and the F/C processing unit F205 executes fuel cut (F/C).

### Operation of ECU

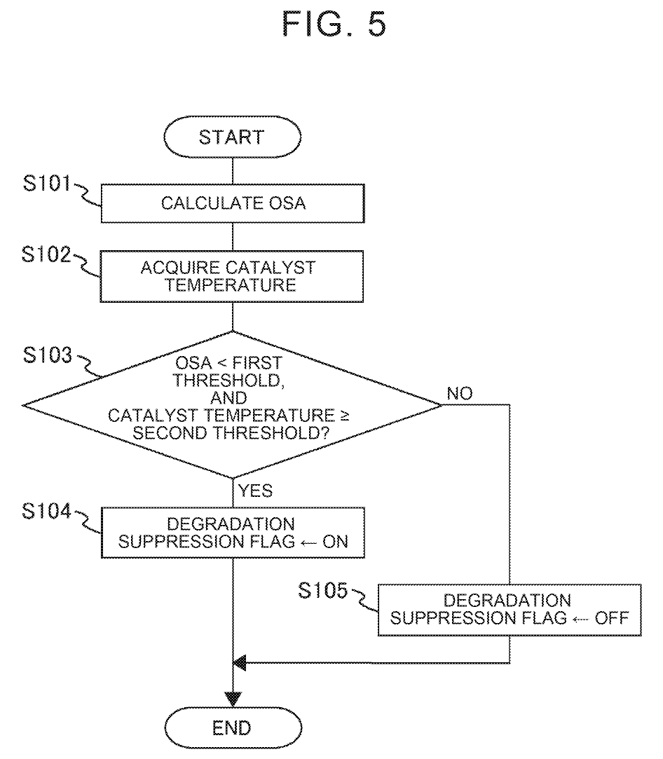

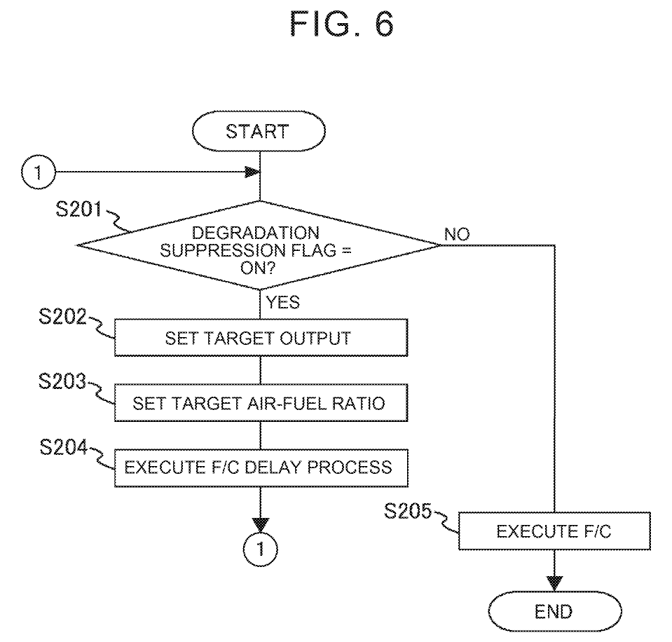

Next, the operation of the ECU 20 in the present embodiment will be described with reference to FIGS. 5 and 6. FIG. 5 is a flowchart showing an example of a first processing routine executed by the ECU 20 for each cycle. FIG. 6 is a flowchart showing an example of a second processing routine executed by the ECU 20 when the F/C condition is satisfied. Although the main execution entity of the first and second processing routines is the processor of the ECU 20, the following description refers to the software modules of the ECU 20 as the execution entities.

In the first processing routine shown in FIG. 5, the OSA calculation unit F201 of the ECU 20 calculates the OSA of the three-way catalyst (step S101). For example, the OSA calculation unit F201 may calculate, for the relevant cycle, the amount of oxygen stored in the three-way catalyst or the amount of oxygen released from the three-way catalyst according to the intake air amount, the fuel injection amount, and the engine air-fuel ratio for that cycle. In that case, when the engine air-fuel ratio is a lean air-fuel ratio, the OSA calculation unit F201 may calculate, according to the intake air amount and the fuel injection amount, the excess amount of oxygen contained in the exhaust gas and add the calculated amount to the previously calculated OSA (the OSA calculated in the immediately preceding cycle). When the engine air-fuel ratio is a rich air-fuel ratio, the OSA calculation unit F201 may calculate, according to the intake air amount and the fuel injection amount, the deficiency of oxygen contained in the exhaust gas and subtracts the calculated deficiency from the previously calculated OSA. When the OSA calculation unit F201 completes step S101, the flag setting unit F202 executes step S102.

In step S102, the flag setting unit F202 acquires the bed temperature of the three-way catalyst (the catalyst temperature) via the catalyst temperature sensor 104. After the flag setting unit F202 completes step S102, it executes step S103.

In step S103, the flag setting unit F202 determines, based on the OSA calculated in step S101 and the catalyst temperature acquired in step S102, whether the fuel-cut delay condition is satisfied. Specifically, the flag setting unit F202 determines whether the OSA is less than the first threshold and whether the catalyst temperature is higher than or equal to the second threshold. When the OSA is less than the first threshold and the catalyst temperature is higher than or equal to the second threshold (yes in step S103), the flag setting unit F202 executes step S104. When the OSA is greater than or equal to the first threshold and/or the catalyst temperature is lower than the second threshold (no in step S103), the flag setting unit F202 executes step S105.

In step S104, the flag setting unit F202 sets the degradation suppression flag to ON. In step S105, the flag setting unit F202 sets the degradation suppression flag to OFF. After the flag setting unit F202 completes step S104 or step S105, the first processing routine ends.

Next, in the second processing routine shown in FIG. 6, the determination unit F203 of the ECU 20 determines whether the fuel-cut delay condition is satisfied (step S201). Specifically, the determination unit F203 determines whether the degradation suppression flag, which is set separately in the first processing routine of FIG. 5, is ON. When the degradation suppression flag is ON, the determination unit F203 determines that the fuel-cut delay condition is satisfied (yes in step S201). In that case, the processor of the ECU 20 operates as the delay processing unit F204 and executes the F/C delay process (steps S202 to S205).

In step S202, the delay processing unit F204 sets a target output of the internal combustion engine 10. Specifically, the delay processing unit F204 first acquires the battery state of charge via the SOC sensor 141. The delay processing unit F204 then specifies the allowable output of the battery 14 according to the acquired state of charge. At that time, the delay processing unit F204 specifies the allowable output corresponding to the acquired battery state of charge, based on data stored in the auxiliary storage device (i.e., data indicating the correlation between battery state of charge and allowable output). The delay processing unit F204 then sets the target output of the internal combustion engine 10 to the engine output equivalent to the specified allowable output. After the target output of the internal combustion engine 10 is set, the delay processing unit F204 executes step S203.

In step S203, the delay processing unit F204 sets a target air-fuel ratio, namely a target value of the engine air-fuel ratio. Specifically, the delay processing unit F204 sets the target air-fuel ratio based on the target output set in step S202 and the correlation shown in FIG. 3 described above. At that time, among the engine air-fuel ratios on the lean side within the exhaust control window of the three-way catalyst, the delay processing unit F204 selects the engine air-fuel ratio at which the engine output matches the target output and the discharged oxygen amount is greatest, and sets the target air-fuel ratio to that engine air-fuel ratio. When there are multiple engine air-fuel ratios at which the discharged oxygen amount is greatest, the delay processing unit F204 may select the engine air-fuel ratio closest to the stoichiometric air-fuel ratio from among those engine air-fuel ratios, and set the target air-fuel ratio to that engine air-fuel ratio. After the target air-fuel ratio is set, the delay processing unit F204 executes step S204.

In step S204, the delay processing unit F204 executes the F/C delay process. Specifically, the delay processing unit F204 controls the internal combustion engine 10 such that, in the next cycle, the engine output becomes the target output set in step S202 and the engine air-fuel ratio becomes the target air-fuel ratio set in step S203. The delay processing unit F204 also controls the generator 13 via the PCU 15 such that all of the engine output of the next cycle is converted into electric power and the converted electric power is used to charge the battery 14. After the processor of the ECU 20 completes step S204, it executes step S201 again.

When it is determined in step S201 that the fuel-cut delay condition is not satisfied (no in step S201), the processor of the ECU 20 operates as the F/C processing unit F205 and executes step S205. In step S205, the F/C processing unit F205 executes fuel cut (F/C) of the internal combustion engine 10. Specifically, the F/C processing unit F205 stops fuel injection and ignition in the next and subsequent cycles. The fuel cut (F/C) of the internal combustion engine 10 is maintained until the F/C condition is no longer satisfied. After the F/C processing unit F205 completes step S205, the processor of the ECU 20 ends the second processing routine shown in FIG. 6.

### Functions and Effects of Embodiment

In the hybrid electric vehicle of the present embodiment, when the fuel-cut delay condition is satisfied at the time the F/C condition is satisfied, the F/C delay process is executed. In the F/C delay process of the present embodiment, the engine air-fuel ratio is set to an air-fuel ratio that is within the exhaust control window of the three-way catalyst and at which the discharged oxygen amount is greatest. The generator 13 is controlled such that all of the engine output generated by the internal combustion engine 10 during the F/C delay process is used to charge the battery 14. Accordingly, the engine air-fuel ratio during the F/C delay process can be made as close to the stoichiometric air-fuel ratio as possible, and the engine output can be offset by charging the battery 14. This makes it possible to supply a sufficient amount of oxygen to the three-way catalyst per unit time, while suppressing transmission of the output of the internal combustion engine to the drive wheels and reducing the possibility that the engine air-fuel ratio deviates from the exhaust control window.

Therefore, the present embodiment can reduce emissions during the F/C delay process and shorten the execution period of the F/C delay process. Moreover, the present embodiment can suppress a decrease in drivability caused by transmission of the engine output to the wheels 18 during the F/C delay process.

### Others

The above embodiment illustrates the following two conditions as examples of the fuel-cut delay condition: (1) the OSA of the three-way catalyst is less than the first threshold, and (2) the temperature (bed temperature) of the three-way catalyst is higher than or equal to the second threshold. However, one of these two conditions may be used.

What is claimed is:

1. A control device for a hybrid electric vehicle equipped with an internal combustion engine, a battery, and a generator, wherein:
a three-way catalyst having oxygen storage capacity is disposed in an exhaust passage of the internal combustion engine;
the generator is configured to charge the battery using output of the internal combustion engine; and
the control device is configured to
determine whether a fuel-cut delay condition is satisfied, when a fuel-cut condition of the internal combustion engine is satisfied,
delay execution of fuel cut of the internal combustion engine for a predetermined period when determination is made that the fuel-cut delay condition is satisfied,
set an engine air-fuel ratio during the predetermined period to a target air-fuel ratio that is within an exhaust control window of the three-way catalyst and leaner than a stoichiometric air-fuel ratio, and
control the generator such that the output generated by the internal combustion engine during the predetermined period is used to charge the battery.

2. The control device according to claim 1, wherein the fuel-cut delay condition includes that an amount of oxygen stored in the three-way catalyst is less than a first threshold.

3. The control device according to claim 1, wherein the fuel-cut delay condition includes that a temperature of the three-way catalyst is higher than or equal to a second threshold.

4. The control device according to claim 1, wherein controlling the engine air-fuel ratio to the target air-fuel ratio includes
acquiring a battery state of charge representing a remaining amount of electrical energy stored in the battery,
setting a target output of the internal combustion engine during the predetermined period according to the battery state of charge, and
setting the target air-fuel ratio according to the target output and a correlation among the output of the internal combustion engine, the engine air-fuel ratio, and an amount of oxygen discharged from the internal combustion engine per unit time.
